(19) United States
(12) Patent Application Publication
(10) Pub. No.: US 2016/0110387 A1
(43) Pub. Date: Apr. 21, 2016

(54) PRODUCT LIFECYCLE MANAGEMENT SYSTEM

(71) Applicant: SOLAR TURBINES INCORPORATED, San Diego, CA (US)

(72) Inventors: Daniel Michael Betry, San Diego, CA (US); Narendernath Miriyala, San Diego, CA (US)

(73) Assignee: SOLAR TURBINES INCORPORATED, San Diego, CA (US)

(21) Appl. No.: 14/518,903

(22) Filed: Oct. 20, 2014

(51) Int. Cl. G06F 17/30

(52) U.S. Cl. CPC G06F 17/30277; G06F 17/3053; G06F 17/30867; G06F 17/30268

(57) ABSTRACT

A method for providing documents and information of a product lifecycle management system to a user system is disclosed. The method includes locating a latest released drawing associated with the component part number in the product lifecycle management database. The method also includes aggregating a part displacement record for each version of the component into a part replacement report. The method further includes providing a graphical user interface to the user system that displays a download link to the latest released drawing and displays a link to the part replacement report with the download link and the link located within a single window.

### TECHNICAL FIELD

The present disclosure generally pertains to product lifecycle management, and is more particularly directed toward a method for searching the product lifecycle management database.

### BACKGROUND

Gas turbine engines include an inlet, a compressor section, a combustor section, a turbine section, and an exhaust. Each of these sections includes a large number of unique parts. Over time these parts are updated and replaced with new revisions. The lifecycle of each of these revisions may be tracked and managed within a product lifecycle management database.

U.S. patent application No. 2005/0171931 to G. Baxter et al. is directed to a method and system for searching a plurality of information databases for records related to an input search term. The method comprises selecting a group of related search terms containing the input search term from a search database of terms arranged in predefined groups according to their relationship with one another. Each term is present within one or more of the information databases. A data repository is searched for terms from the selected group, the data repository comprising selected data previously extracted from the records of each information database. The search identifies the corresponding records within the information databases which contain the terms within the selected group.

The present disclosure is directed toward overcoming one or more of the problems discovered by the inventors or that is known in the art.

### SUMMARY OF THE DISCLOSURE

A method for providing documents and information of a product lifecycle management system to a user system is disclosed. In embodiments, the method includes determining a component part number of a component based on a user input received from the user system. The method also includes locating a latest released drawing associated with the component part number in the product lifecycle management database. The method further includes aggregating a part displacement record for each version of the component into a part replacement report. The method yet further includes providing a graphical user interface to the user system that displays a download link to the latest released drawing and displays a link to the part replacement report with the download link and the link located within a single window.

In some embodiments, the method also includes generating a table to be displayed on the user system including the part number, the part name, the part version, and the state for each of the assembly components related to the latest version of the component and displaying a link to the table within the single window.

In some embodiments, the method also includes determining a hierarchal assembly structure for the latest released version of the component, generating a table to be displayed on the user system including the hierarchal assembly structure, and displaying a link to the table within the single window.

In some embodiments, the method also includes displaying a link to a report generation graphical user interface. The report generation graphical user interface is configured to obtain an output selection and a generate report selection from the user system.

In some embodiments, the method also includes determining a latest version of the component based on the component part number by querying the product lifecycle management database and providing a link to an information page for the latest version of the component stored in the product lifecycle management database.

In some embodiments, the method also includes appending a computer aided drawing object extension to the component part number to locate a drawing related to the component part number in the product lifecycle management database, fetching a visual of the component from the drawing, and displaying the visual of the component within the single window.

### BRIEF DESCRIPTION OF THE DRAWINGS

FIG. 1 is a functional block diagram of a product lifecycle management system 100 for tracking the lifecycle of the various components of a machine or machines, such as a gas turbine engine.

FIG. 2 is a functional block diagram of the search system of FIG. 1.

FIG. 3 is a flowchart of a method for providing the current drawing of the component.

FIG. 4 is a flowchart of a method for providing a bill of materials for the component.

FIG. 5 is a flowchart of a method for providing enterprise resource planning bill of materials for the component.

FIG. 6 is a flowchart of a method for providing a part replacement report for the component.

FIG. 7 is a flowchart of a method for providing a multilevel assembly report for the component.

### DETAILED DESCRIPTION

The systems and methods disclosed herein include a product lifecycle management system and a search system for providing quick access to information from the product lifecycle management system. In embodiments, various links to information associated with a part number are aggregated and displayed in a single window within a graphical user interface based off of a part number input. The information may include the latest released drawing, a part replacement report, a bill of materials, enterprise resource planning information, and assembly information. Providing access to this information from a single location based off of a part number input may allow a user with little to no training with the product lifecycle management system to access this information. Further providing access to this information from a single location may reduce the time it takes to access this information by reducing the number of intermediate steps to access the information.

FIG. 1 is a functional block diagram of a product lifecycle management system 100 for tracking the lifecycle of the various components of a machine or machines, such as a gas turbine engine. The product lifecycle management system 100 may have a server 120, a product lifecycle management database 130, an enterprise resource planning database 135, user system(s) 140, and a search system 150 connected via a network 110. The server 120 may host and/or execute one or more of the various functions and/or software modules described herein. In addition, the server 120 is communicatively connected to the user systems 140, the product lifecycle management database 130, and enterprise resource planning database 135. In some embodiments, the product lifecycle management system 100 includes more than one server 120 communicatively connected.

In some embodiments more than one network 110 connects the various systems. The network 110 may include one or more private networks. In some embodiments, the networks 110 include the internet connected to the one or more private networks. The server(s) 120 may communicate with the user systems 140 over the private network and/or over the internet using standard transmission protocols.

In an alternative embodiment, server(s) 120 may not be dedicated servers, and may instead be cloud instances, which utilize shared resources of one or more servers. Furthermore, while FIG. 1 illustrates the server(s) 120 being connected to the user systems 140 through a single set of network(s) 110, it should be understood that the server(s) 120 may be connected to the various systems via different sets of one or more networks. For example, the server(s) 120 may be connected to user systems 140 via a combination of the Internet and cellular networks, but may be connected to the product lifecycle management database 130 and the enterprise resource planning database 135 via intranet connections. It should also be understood that user systems 140 may comprise any type or types of computing devices capable of wired and/or wireless communication, including without limitation, desktop computers, laptop computers, tablet computers, servers, and smart phones or other mobile devices. In addition, while only three user systems 140 and one server 120 are illustrated, it should be understood that the network 110 may comprise any number of user systems and any number of servers or sets of servers.

Server(s) 120 may provide secure communication between user systems 140. Server(s) 120 may also store, or caused to be stored, a record of the communications between user systems 140. The records may be stored securely on the server(s) 120 or on a dedicated storage device. The transmission/storage of the communication between user systems 140 may be protected in various ways, such as by encryption, a virtual private network (VPN), and public-key cryptography.

The server(s) 120 may provide an application programming interface (API) which defines the manner in which user system(s) 140 may interact with the server(s) 120. Thus, the user system(s) 140, which may themselves be servers, can define their own user interfaces, and rely on the server(s) 120 to implement the backend processes, functionality, storage, etc., described herein.

Server(s) 120 may also include web servers which host one or more websites or web services. In embodiments in which a website is provided, the website may comprise one or more user interfaces, including, for example, webpages generated in HyperText Markup Language (HTML) or other language. The server(s) 120 transmit or serve these user interfaces in response to requests from user system(s) 140. These user interfaces may be served in the form of a wizard, in which case two or more user interfaces may be served in a sequential manner, and one or more of the sequential user interfaces may depend on the user's interaction with one or more preceding user interfaces.

The requests to server(s) 120 and the responses from server(s) 120, including the user interfaces, may both be communicated through network(s) 110, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like. The server(s) 120 may also respond to other requests from the user system(s) 140. For example, a user system may submit data (e.g., user data, form data, etc.) to be stored in one or more databases, such as product lifecycle management database 130 and the enterprise resource planning database 135, locally and/or remotely accessible to the server(s) 120. Any suitable database may be utilized, including without limitation MySQL, Oracle, IBM, Microsoft SQL, Sybase, Access, and the like, including cloud-based database instances. Data may be sent to the server(s) 120, for instance, using the well-known POST request supported by HTTP. This data, as well as other requests, may be handled, for example, by a servlet or other server-side web technology executed by the server(s) 120.

In embodiments in which a web service is provided, the server(s) 120 may receive requests from user system(s) 140, and provide responses in eXtensible Markup Language (XML) and/or another suitable format.

User systems 140 may access the server(s) 120 through APIs provided by the server(s) 120 or through a web based application provided by the sever(s) 120. Access to the server(s) 120 may be access protected, such as by a password. The user may be required to supply/input the access protection information that is submitted to the server 120 by the user system 140. The user systems 140 may include various executable software program modules that can be stored on the memory of the user systems 140 and executed by the processor of the user systems 140. The memory includes a non-transitory computer readable medium used to store program instructions executable by the processor.

The product lifecycle management database 130 may have information about each component of the machine including information related to the previous versions of the component, the current version of the component, and in progress revisions to the component as well as the associated part number for each. The information may include a current image of the component, drawings for each version of the component, a related bill of materials, the component displacement, and which assembly the component is used in. The drawings may be associated with the part number. The related bill of materials may be the bill of materials for the assembly that the component is part of. The component displacement identifies whether a given part number for the component is the current version and if not, identifies which part number replaces the given part number as well as identifies which is the current part number.

Some of the component information may be stored or aggregated in an enterprise resource planning database 135. The enterprise resource planning database 135 may have a component inventory for each component of the machine. The component inventory may include product cost, qualification, inventory, sourcing, and configuration decisions. The enterprise resource planning database 135 may be part of an order execution system used to create and execute purchasing, manufacturing, and sales orders of the component, or may be an aggregate of information from a separate order execution database and information from the product lifecycle management database 130.

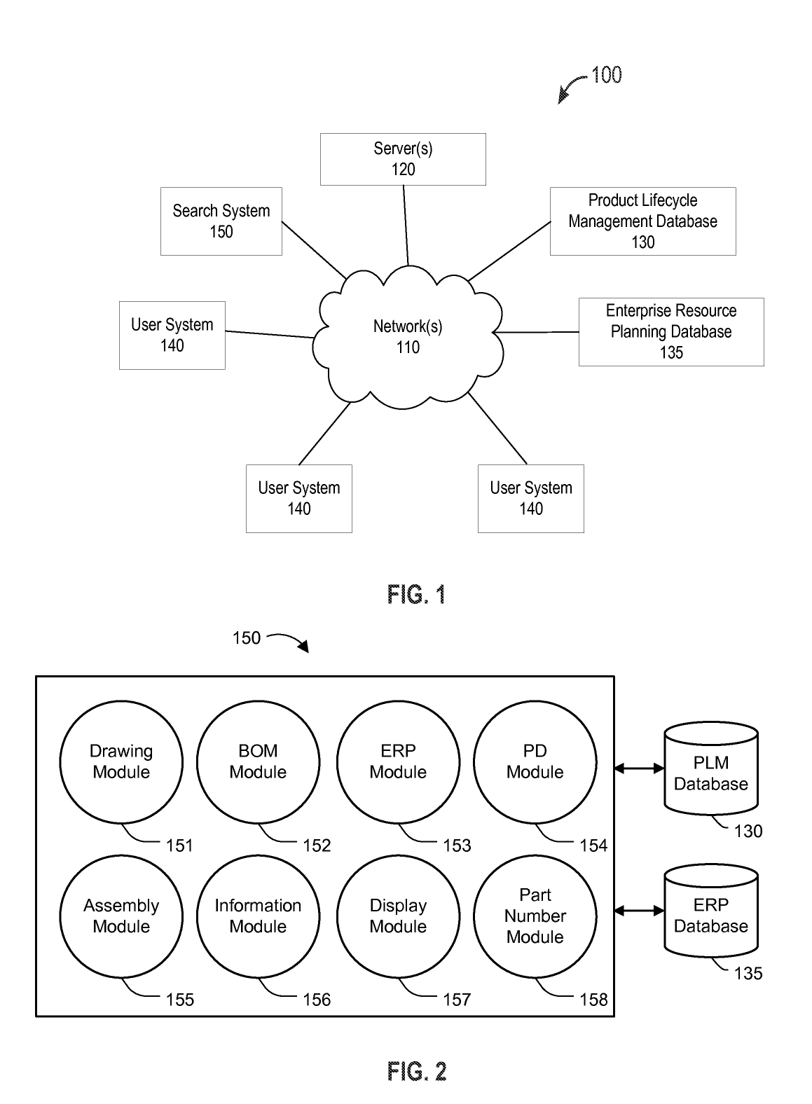

FIG. 2 is a functional block diagram of the search system 150 of FIG. 1. The search system 150 may be implemented on the server 120, on a user system 140, and/or on a separate computer. The search system 150 may include a part number module 158, a drawing module 151, a bill of materials module 152, an enterprise resource planning module 153, a part displacement module 154, an assembly module 155, an information module 156, and a display module 157. In one embodiment, each of the modules is implemented as software executed on the server 120, on a user system 140, and/or on a separate computer.

The part number module 158 may be configured to determine the part number to be used by the search system 150 and the various modules. In embodiments, the part number module 158 obtains the part number directly from the user through a search bar or a graphical user interface provided by the display module 157. In other embodiments, the part number module 158 determines the part number based on search terms provided by the user.

The drawing module 151 may be configured to retrieve the current version of the drawing from the product lifecycle management database 130. The drawing module 151 searches the product lifecycle management database 130 for the latest released drawing associated with the part number and provides a link to that drawing. The drawing module 151 is configured to ignore drawings that are marked as a work in progress.

The bill of materials module 152 may be configured to search the product lifecycle management database 130 for the latest version of the component, to determine the assembly that the component is part of, and to determine the various components used in that assembly. The bill of materials module 152 may then provide a link to a table including the part number, name, version, and state for each component of the assembly. The bill of materials may also provide the number of objects within the assembly. In some embodiments, the bill of materials module 152 generates the table.

The enterprise resource planning module 153 may be configured to provide a report generation page, which can be used to extract the combined information of the product lifecycle management database 130 and the order execution database from the enterprise resource planning database 135 to generate an enterprise resource planning bill of materials. The enterprise resource planning module 153 may also be configured to provide a link to the report generation page.

The part displacement module 154 may be configured to provide a link a part replacement report. The part replacement report may be determined by generated by the part displacement module 154 or may be maintained on the product lifecycle management database 130. The part displacement report aggregates the part displacement records for the various versions of the component showing the part number with each subsequent part number that it replaced or that replaced it.

The assembly module 155 may be configured to generate and provide a link to a table that displays a multilevel assembly report. The Multilevel assembly report may display the latest released version of the component and each level of assembly that the component is located in.

The information module 156 may be configured to determine the latest released version of the component and provide a link to an information page of the product lifecycle management system.

The display module 157 may be configured to display a visual of the component. If the part number searched for is associated with a CAD object of the part, the display module 157 retrieves the visual from product lifecycle management database 130 and displays that CAD object on the user system 140. If the part number searched for is not associated with a CAD object, the display module 157 appends the part number with CAD object extension, such as .prt or .asm and fetches the visual from the drawing with the part number as its name with the CAD object extension from the product lifecycle management database 130.

The display module 157 is also configured to provide the one or more resultants or a link to the one or more of the resultants provided by the various modules, such as the visual of the component, the current drawing, the bill of materials, the enterprise resource planning bill of materials, the part displacement information, and the component information page. This may be done using a graphical user interface (GUI) that graphically represents each resultant, such as by text, and provides a hyperlink to the resultant. If no resultant is available, the graphic representation may be displayed without a hyperlink or may not be displayed at all.

In some embodiments, the display module 157 also displays a GUI with an area for entering the part number that the user wishes to be searched. In other embodiments, the search is implemented within a browser search bar.

### INDUSTRIAL APPLICABILITY

Product lifecycle management systems may be used to configure and manage product information during every step of the product lifecycle from concept to obsolescence. A product lifecycle management system may support a product manufacturer's engineering, manufacturing, sales, and customer service business processes.

Product lifecycle management systems may be robust and may require training on how to use and navigate through the system to access information contained within the product lifecycle management database 130. Often retrieval of information requires multiple clicks and multiple pages to navigate through. Users often perform a keyword search and are not sure where to go when the search returns a large number of results.

The search system 150 as disclosed herein can provide commonly accessed documents and information based on a part number or document number search in one or two clicks. A user can locate these documents without any knowledge of the product lifecycle management system and with little to know training. Access times to the documents and information may be reduced by up to 50%.

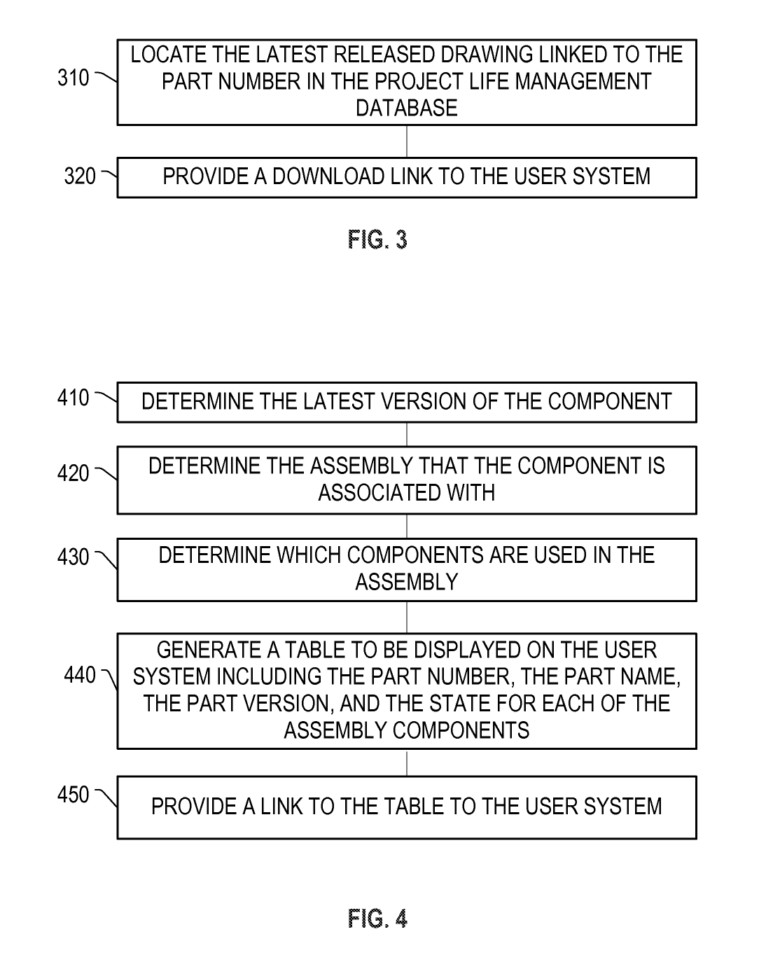

FIGS. 3 to 7 illustrate the various methods that can be used to provide a user with commonly accessed documents and information using the search system 150, such as a current image of the component, the current drawing of the component, a related bill of materials, a component inventory for the component, the component displacement, and which assembly the component is used in. Any combination of the methods illustrated in FIGS. 3 to 9 can be performed using search system 150. Any combination of the methods illustrated in FIGS. 3 to 8 may begin with obtaining the part number of the component from information provided by the user. This may be accomplished by receiving the part number at the search system 150 from the user system 140 or may be accomplished by receiving keywords from the user system 140 at the search system 150 and determining the part number from the keywords at the search system 150. Once the part number is obtained, the methods below can be performed in any order.

FIG. 3 is a flowchart of a method for providing the current drawing of the component. The method includes locating the latest released drawing associated with the part number in the product lifecycle management database 130 at step 310. This may include searching for the highest version number of the drawing that is not marked as a work in progress. The method also includes providing a download link to the user system 140 at step 320. In embodiments, the download link is provided to the display module 157. The display module 157 then displays the download link in a GUI on the user system 140.

FIG. 4 is a flowchart of a method for providing a bill of materials for the component. The method includes determining the latest version of the component at step 410. Step 410 may include querying the product lifecycle management database 130 for the latest replacement part number related to the part number obtained. The method also includes determining the assembly that the component is associated with at step 420. Step 420 may include querying the product lifecycle management database 130 for the assembly information for the latest version of the component. The method further includes determining which components are used in the assembly at step 430. Step 430 may include querying the product lifecycle management database 130 for the component list of the assembly. The method yet further includes generating a table to be displayed on the user system including the part number, the part name, the part version, and the state for each of the assembly components at step 440. The method still further includes providing a link to the table to the user system 140 at step 450. Step 430 may include querying the product lifecycle management database 130 for the part number, name, version, and state for each component and generating a table to be displayed on the user system. In embodiments, the link is provided to the display module 157. The display module 157 then displays the link in the GUI on the user system 140.

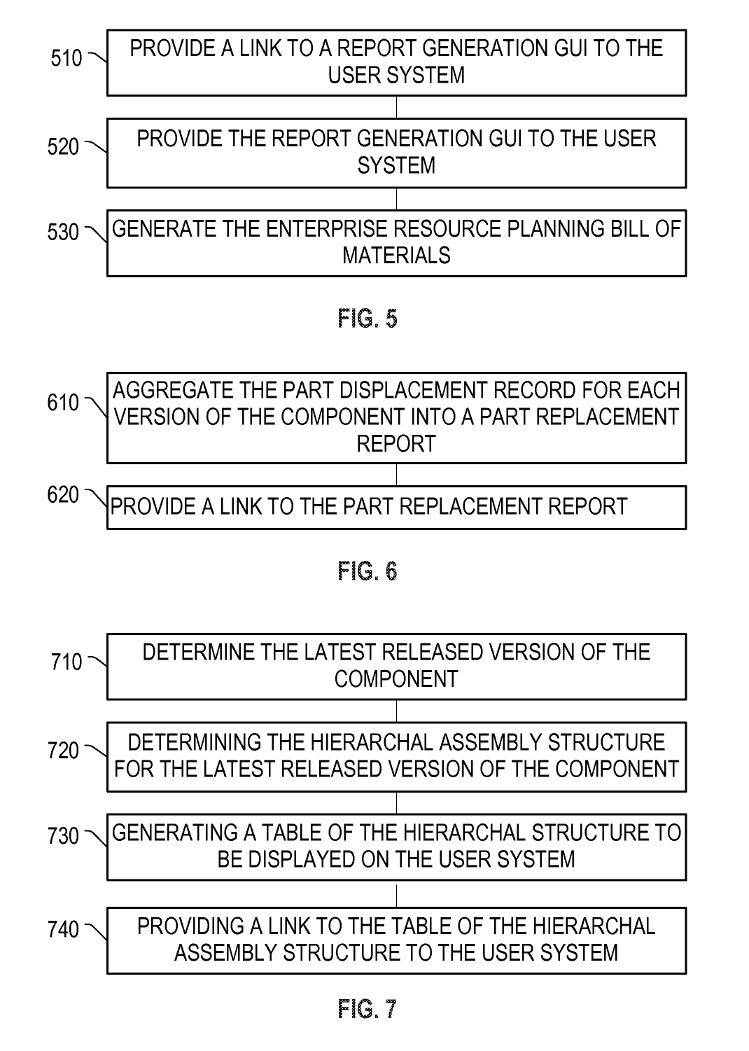

FIG. 5 is a flowchart of a method for providing enterprise resource planning bill of materials for the component. The method includes providing a link to a report generation GUI to the user system at step 510. In embodiments, the link is provided to the display module 157. The display module 157 then displays the link in the GUI on the user system 140. The method also includes providing the report generation GUI to the user system at step 520. The report generation GUI may be configured to obtain a part number input, an output selection, and a generate report selection from the user system 140. The report generation GUI may also be provided to the display module 157 to be displayed on the user system 140. The method further includes generating the enterprise resource planning bill of materials at step 530. Step 530 may include aggregating information from an order execution database and from the product lifecycle management database 130 in an enterprise resource planning database 135, such as product cost, qualification, inventory, sourcing, and configuration decisions. Step 530 may also include extracting the information from the enterprise resource planning database 135 and outputting the information into a spreadsheet that is provided to the user system 140.

FIG. 6 is a flowchart of a method for providing a part replacement report for the component. The method includes aggregating the part displacement record for each version of the component into a part replacement report at step 610. The method also includes providing a link to the part replacement report at step 620. In embodiments, the link is provided to the display module 157. The display module 157 then displays the link in a GUI on the user system 140.

FIG. 7 is a flowchart of a method for providing a multilevel assembly report for the component. The method includes determining the latest released version of the component at step 710. Step 710 may include querying the product lifecycle management database 130 for the latest released part number. The method also includes determining the hierarchal assembly structure for the latest released version of the component at step 720. Step 720 may include querying the product lifecycle management database 130 to determine which assembly the latest released component is used in and to determine where each subsequent assembly is used. The method further includes generating a table of the hierarchal structure to be displayed on the user system 140 at step 730. In embodiments, the table is provided to the display module 157, which then displays the table on the user system 140. The method still further includes providing a link to the table of the hierarchal assembly structure to the user system 140 at step 740. In embodiments, the link is provided to the display module 157. The display module 157 then displays the link in a GUI on the user system 140.

In some embodiments, the product lifecycle management system maintains an information page within the product lifecycle management database 130 related to each part number. As part of the methods disclosed herein, the display module 157 may provide a link to the information page associated with the part number. The methods disclosed herein may further include aggregating the various links into a single GUI and providing each of the links within a single window of the GUI. In some embodiments, the method includes providing an image of the component in the single window of the GUI.

Those of ordinary skill in the art will appreciate that the various illustrative logical blocks, modules, and algorithms described in connection with the embodiments disclosed herein can often be implemented as electronic hardware, computer software, or combinations of both. To clearly illustrate this interchangeability of hardware and software, various illustrative components, units, blocks, modules, and operations have been described above generally in terms of their functionality. Whether such functionality is implemented as hardware or software depends upon the particular system and design constraints imposed on the overall system. Persons of ordinary skill in the art can implement the described functionality in varying ways for each particular system, but such implementation decisions should not be interpreted as causing a departure from the scope of the invention. In addition, the grouping of functions within a unit, module, block or operation is for ease of description. Specific functions or operations can be moved from one unit, module or block without departing from the invention. Electronic content may include, for example, but is not limited to, data and/or applications which may be accessed through the system or systems.

The various illustrative logical blocks, units, operations and modules described in connection with the example embodiments disclosed herein, may be implemented or performed with, for example, but not limited to, a processor, such as a general purpose processor, a digital signal processor (“DSP”), an application-specific integrated circuit (“ASIC”), a field programmable gate array (“FPGA”) or other programmable logic devices, such as a PLC, discrete gate or transistor logic, discrete hardware components, or any combination thereof designed to perform the functions described herein. A general-purpose processor may be, for example, but not limited to, a microprocessor, but in the alternative, the processor may be any processor, controller, or microcontroller. A processor may also be implemented as a combination of computing devices, for example, but not limited to, a combination of a DSP and a microprocessor, a plurality of microprocessors, one or more microprocessors in conjunction with a DSP core, or any other such configuration.

The operations of a method or algorithm and the processes of a block or module described in connection with the example embodiments disclosed herein may be embodied directly in hardware, in a software module (or unit) executed by a processor, or in a combination of the two. A software module may reside in, for example, but not limited to, random access memory (“RAM”), flash memory, read-only memory (“ROM”), erasable programmable read only memory (EPROM), electrically erasable programmable read only memory (“EEPROM”), registers, hard disk, a removable disk, a compact disk (“CD-ROM”), or any other form of machine or non-transitory computer readable storage medium. An exemplary storage medium may be coupled to the processor such that the processor can read information from, and write information to, the storage medium. In the alternative, the storage medium may be integral to the processor. The processor and the storage medium may reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for providing access to information of a product lifecycle management system to a user system, the product lifecycle management system including a product lifecycle management database, the method comprising:
determining a component part number of a component based on a user input received from the user system;
locating a latest released drawing associated with the component part number in the product lifecycle management database;
aggregating a part displacement record for each version of the component into a part replacement report; and
providing a graphical user interface to the user system that displays a download link to the latest released drawing and displays a link to the part replacement report with the download link and the link located within a single window.

2. The method of claim 1, further comprising:
determining a latest version of the component based on the component part number by querying the product lifecycle management database;
determining an assembly that the latest version of the component is associated with;
querying the product lifecycle management database to determine assembly components associated with the assembly;
querying the product lifecycle management database for a part number, a part name, a part version, and a state for each of the assembly components including the latest version of the component;
generating a table to be displayed on the user system including the part number, the part name, the part version, and the state for each of the assembly components; and
displaying a second link to the table within the single window.

3. The method of claim 1, further comprising:
determining a latest version of the component based on the component part number by querying the product lifecycle management database;
determining a hierarchal assembly structure for the latest released version of the component;
generating a table to be displayed on the user system including the hierarchal assembly structure;
displaying a second link to the table within the single window.

4. The method of claim 1, further comprising:
displaying a second link to a report generation graphical user interface, the report generation graphical user interface configured to obtain an output selection and a generate report selection from the user system.

5. The method of claim 1, wherein the graphical user interface is part of a web based application.

6. The method of claim 1, further comprising determining a latest version of the component based on the component part number by querying the product lifecycle management database and providing a second link to an information page for the latest version of the component stored in the product lifecycle management database.

7. The method of claim 1, further comprising:
appending a computer aided drawing object extension to the component part number to locate a drawing related to the component part number in the product lifecycle management database;
fetching a visual of the component from the drawing; and
displaying the visual of the component within the single window.

8. A method for providing access to information of a product lifecycle management system to a user system, the product lifecycle management system including a product lifecycle management database, the method comprising:
determining a component part number of a component based on a user input received from the user system;
determining a latest version of the component based on the component part number by querying the product lifecycle management database;
determining an assembly that the latest version of the component is associated with;
querying the product lifecycle management database to determine assembly components associated with the assembly;
querying the product lifecycle management database for a part number, a part name, a part version, and a state for each of the assembly components including the latest version of the component;
generating a first table to be displayed on the user system including the part number, the part name, the part version, and the state for each of the assembly components;
determining a hierarchal assembly structure for the latest released version of the component;
generating a second table to be displayed on the user system including the hierarchal assembly structure;
providing a graphical user interface to the user system that displays a first link to the first table and a second link to the second table with the first link and the second link located within a single window.

9. The method of claim 8, further comprising aggregating a part displacement record for each version of the component into a part replacement report and displaying a third link to the part replacement report within the single window.

10. The method of claim 9, further comprising locating a latest released drawing associated with the part number in the product lifecycle management database and displaying a download link to the latest released drawing within the single window.

11. The method of claim 10, further comprising:
displaying a fourth link to a report generation graphical user interface, the report generation graphical user interface configured to obtain an output selection and a generate report selection from the user system.

12. The method of claim 11, further comprising:
appending a computer aided drawing object extension to the component part number to locate a drawing related to the component part number in the product lifecycle management database;
fetching a visual of the component from the drawing; and
displaying the visual of the component within the single window.

13. The method of claim 12, further comprising providing a link to an information page for the latest version of the component stored in the product lifecycle management database.

14. The method of claim 13, wherein the graphical user interface is part of a web based application.

15. A search system for a product lifecycle management system including a product lifecycle management database, the search system comprising:
a part number module configured to provide a part number for a component based on a user input at a user system;
a drawing module configured to locate a latest released drawing associated with the part number in the product lifecycle management database including searching for a drawing associated with the part number with a highest version number that is not marked as a work in progress;
an assembly module configured to:
determine a latest version of the component based on the component part number by querying the product lifecycle management database,
determine a hierarchal assembly structure for the latest released version of the component, and
generate a table to be displayed on the user system including the hierarchal assembly structure; and
a display module configured to provide a graphical user interface to the user system that displays a download link to the latest released drawing and a link to the table with the download link and the link located within a single window.

16. The search system of claim 15, further comprising a part displacement module configured to aggregate a part displacement record for each version of the component into a part replacement report; wherein the display module is also configured to display a second link to the part replacement report within the single window.

17. The search system of claim 15, further comprising a bill of materials module configured to:
determine an assembly that the latest version of the component is associated with;
query the product lifecycle management database to determine assembly components associated with the assembly;
query the product lifecycle management database for a part number, a part name, a part version, and a state for each of the assembly components including the latest version of the component; and
generate a second table to be displayed on the user system including the part number, the part name, the part version, and the state for each of the assembly components;
wherein, the display module is also configured to display a second link to the second table within the single window.

18. The search system of claim 15, wherein the display module is configured to display a second link to a report generation graphical user interface, and wherein the search system further comprises an enterprise resource planning module configured to generate an enterprise resource planning bill of materials based on an output selection by a user received from the user system.

19. The search system of claim 15, wherein the display module is configured to display the graphical user interface is part of a web based application.

20. The search system of claim 15, wherein the display module is configured to provide a second link to an information page for the latest version of the component stored in the product lifecycle management database.
